(19) United States
(12) Patent Application Publication
(10) Pub. No.: US 2017/0087042 A1
(43) Pub. Date: Mar. 30, 2017

(54) METHOD AND APPARATUS FOR ADJUSTING CLAMPING FORCE

(71) Applicant: Samsung Electronics Co., Ltd., Suwon-si (KR)

(72) Inventors: Joon-Kee CHO, Yongin-si (KR); Taesin HA, Seongnam-si (KR); Youngbo SHIM, Seoul (KR); Byung-Kwon CHOI, Suwon-si (KR)

(73) Assignee: Samsung Electronics Co., Ltd., Suwon-si (KR)

(21) Appl. No.: 15/171,329

(22) Filed: Jun. 2, 2016

(30) Foreign Application Priority Data
Sep. 25, 2015 (KR) 10-2015-0136809

(51) Int. Cl. A61H 3/00; A61H 1/02

(52) U.S. Cl. CPC A61H 3/00; A61H 1/0262; A61H 2003/007; A61H 2201/165; A61H 2201/163; A61H 2201/1642; A61H 2201/5007; A61H 2201/5056; A61H 2201/5061; A61H 2230/625

(57) ABSTRACT

An apparatus and method for adjusting a clamping force of a fixing portion of a walking assistance apparatus is disclosed. The apparatus and method may measure pressures at two points positioned between a fixing portion and a body of a user, calculate a clamping force of the fixing portion based on the pressures, and control the fixing portion to output the clamping force of the fixing portion.

### CROSS-REFERENCE TO RELATED APPLICATION

This application claims under 35 U.S.C. §119 to Korean Patent Application No. 10-2015-0136809, filed on Sep. 25, 2015, at the Korean Intellectual Property Office, the entire contents of which are incorporated herein by reference in its entirety.

### BACKGROUND

1. Field

Example embodiments relates to a method and/or apparatus for adjusting a clamping force of a fixing portion. For example, at least one example embodiment relates to a method and/or apparatus for adjusting a clamping force of a fixing portion used for a walking assistance apparatus.

2. Description of the Related Art

With the onset of rapidly aging societies, many people are experiencing inconvenience and/or pain from joint problems. Thus, there is a growing interest in walking assistance apparatuses that enable the elderly and/or patients having joint problems to walk with less effort. Furthermore, walking assistance apparatuses for intensifying muscular strength of human bodies may be useful for military purposes.

A walking assistance apparatus may assist a user with walking by providing an assistance force to a leg. A fixing portion allowing the walking assistance apparatus to be coupled with a leg may be used to provide the assistance force to the leg. To provide the assistance force efficiently, it may be desirable to couple the fixing portion to the user using a clamping force. Conventionally, when the clamping force of the fixing portion is strong, the user may sense pressure and discomfort due to the clamping force.

### SUMMARY

Some example embodiments relate to a method of adjusting a clamping force applied to a user.

In some example embodiments, the method includes measuring pressures at at least two points between a fixing portion of a walking assistance apparatus and a body of the user; calculating an adjusted clamping force of the fixing portion based on the pressures; and controlling the fixing portion to apply the adjusted clamping force to the user.

In some example embodiments, the method further includes controlling the fixing portion to apply an initial clamping force to the user.

In some example embodiments, the method further includes determining if an operation mode of the walking assistance apparatus is a walking assistance mode; and wherein the measuring measures the pressures when the determining determines that the operation mode is the walking assistance mode.

In some example embodiments, the calculating of the adjusted clamping force includes calculating a difference between the pressures; and calculating the adjusted clamping force based on the difference.

In some example embodiments, the calculating of the adjusted clamping force based on the difference includes maintaining an initial clamping force when the difference is less than a threshold.

In some example embodiments, the calculating of the adjusted clamping force based on the difference includes calculating the adjusted clamping force based on the difference and an assistance force applied to the walking assistance apparatus when the measuring the pressures measures the pressures at the at least two points.

In some example embodiments, the method further includes comparing the adjusted clamping force to a maximum clamping force; and setting the adjusted clamping force as a maximum clamping force when the adjusted clamping force exceeds the maximum clamping force.

In some example embodiments, the calculating of the adjusted clamping force includes determining a gait state of the body; and calculating the adjusted clamping force based on the gait state.

Some example embodiments relate to an apparatus configured to adjust a clamping force applied to a user.

In some example embodiments, the apparatus includes a pressure sensor configured to measure pressures at at least two points between a fixing portion of a walking assistance apparatus and a body of the user; and a processor configured to, calculate an adjusted clamping force of the fixing portion based on the pressures, and control the fixing portion to apply the adjusted clamping force to the user.

In some example embodiments, the two points are symmetrical with each other with respect to the body.

In some example embodiments, the processor is configured to control the fixing portion to apply the adjusted clamping force by adjusting an amount of air in the fixing portion.

In some example embodiments, the processor is configured to control the fixing portion to apply the adjusted clamping force by adjusting a length of the fixing portion.

In some example embodiments, the processor is configured to control the fixing portion to apply an initial clamping force to the user.

In some example embodiments, the processor is configured to determine if an operation mode of the walking assistance apparatus is a walking assistance mode, and instruct the pressure sensor to measure the pressures when the operation mode is the walking assistance mode.

In some example embodiments, the processor is configured to calculate a difference between the pressures, and calculate the adjusted clamping force based on the difference.

In some example embodiments, the processor is configured to compare the adjusted clamping force to a preset maximum clamping force, and set the adjusted clamping force as a maximum clamping force when the adjusted clamping force exceeds the maximum clamping force.

In some example embodiments, the processor is configured to determine a gait state of the body and calculate the adjusted clamping force based on the gait state.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIGS. 1 and 2 illustrate examples of a walking assistance apparatus according to at least one example embodiment;

FIG. 3 is a block diagram illustrating an example of an apparatus for adjusting a clamping force according to at least one example embodiment;

FIG. 4 is a flowchart illustrating an example of a method of adjusting a clamping force according to at least one example embodiment;

FIG. 5 illustrates an example of a pressure sensor positioned between a fixing portion and a body according to at least one example embodiment;

FIG. 6 illustrates an example of an arrangement of pressure sensors according to at least one example embodiment;

FIG. 7 is a flowchart illustrating an example of a method of calculating a clamping force according to at least one example embodiment;

FIG. 8 is a flowchart illustrating another example of a method of calculating a clamping force according to at least one example embodiment;

FIGS. 9 and 10 illustrate examples of a fixing portion of which a length is adjusted according to at least one example embodiment;

FIG. 11 illustrates an example of an air pressure type fixing portion according to at least one example embodiment;

FIG. 12 is a flowchart illustrating an example of a method of determining an operation mode according to at least one example embodiment; and

FIG. 13 is a flowchart illustrating an example of a method of setting a maximum clamping force according to at least one example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

The terminology used herein is for the purpose of describing particular example embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, Central Processing Unit (CPU), a controller, an arithmetic logic unit (ALU), a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blu-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Various example embodiments will now be described more fully with reference to the accompanying drawings in which some example embodiments are shown. In the drawings, the thicknesses of layers and regions are exaggerated for clarity.

<Outline of Walking Assistance Device>

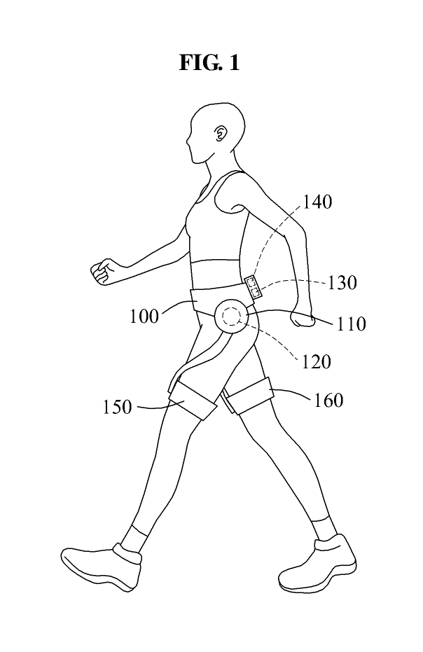

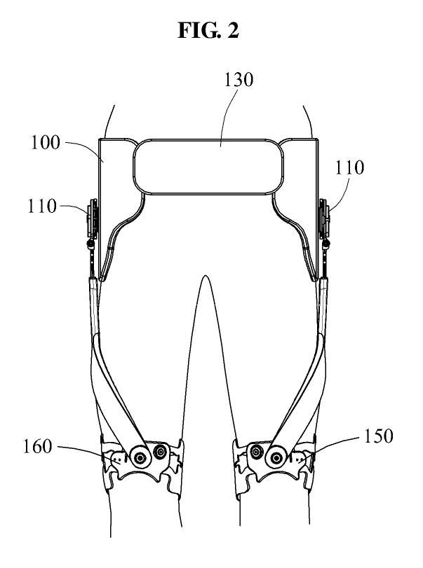

FIGS. 1 and 2 illustrate examples of a walking assistance apparatus according to at least one example embodiment.

Referring to FIG. 1, a walking assistance apparatus 100 may be attached to a user to assist walking of the user. The walking assistance apparatus 100 may be a wearable device.

Although FIG. 1 illustrates a hip-type walking assistance apparatus, the type of the walking assistance apparatus is not limited thereto. For example, the walking assistance apparatus may be applicable to a walking assistance apparatus that supports an entire pelvic limb, and a walking assistance apparatus that supports a portion of a pelvic limb. The walking assistance apparatus that supports a portion of a pelvic limb may be applicable to a walking assistance apparatus that supports up to a knee, and/or a walking assistance apparatus that supports up to an ankle.

Example embodiments described with reference to FIG. 1 may be applicable to a hip-type walking assistance device, but are not limited thereto. The example embodiments may be applicable to all devices that assist walking of a user.

In an example embodiment, the walking assistance apparatus 100 includes a driving portion 110, a sensor portion 120, an inertial measurement unit (IMU) sensor 130, a controller 140, and fixing portions 150 and 160.

The driving portion 110 may drive a hip joint of a user. For example, the driving portion 110 may be disposed on a right hip portion and/or a left hip portion of the user.

The driving portion 110 may include a motor configured to generate a rotational torque.

The sensor portion 120 may measure an angle of the hip joint of the user while the user is walking. Information on the angle of the hip joint sensed by the sensor portion 120 may include an angle of a right hip joint, an angle of a left hip joint, a difference between the angle of the right hip joint and the angle of the left hip joint, and/or motion directions of both hip joints. For example, the sensor portion 120 may be disposed in the driving portion 110.

In an example, the sensor portion 120 may include a potentiometer. The potentiometer may sense an R-axis joint angle, an L-axis joint angle, an R-axis joint angular velocity, and/or an L-axis joint angular velocity with respect to a gait motion of the user.

The IMU sensor 130 may measure acceleration information and pose information while the user is walking. For example, the IMU sensor 130 may sense an X-axis acceleration, a Y-axis acceleration, a Z-axis acceleration, an X-axis angular velocity, a Y-axis angular velocity, and/or a Z-axis angular velocity with respect to the gait motion of the user.

The walking assistance apparatus 100 may detect a point at which a foot of the user lands based on the acceleration information measured by the IMU sensor 130.

A pressure sensor (not shown) may be disposed on a sole of the user to detect the landing point of the foot of the user.

In addition to the sensor portion 120 and the IMU sensor 130, the walking assistance apparatus 100 may include another sensor, for example, an electromyogram (EMG) sensor, configured to sense a change in a biosignal or a momentum of the user with respect to the gait motion.

The controller 140 may control the driving portion 110 to output an assistance force to assist walking of the user. For example, in the hip-type walking assistance apparatus 100, two driving portions 110, in detail, a left hip driving portion and a right hip driving portion, may be provided. The controller 140 may output a control signal to control the driving portions 110 to generate torques.

The controller 140 may include a memory and a processor.

The memory may be a non-volatile memory, a volatile memory, a hard disk, an optical disk, and a combination of two or more of the above-mentioned devices. The memory may be a non-transitory computer readable medium. The non-transitory computer-readable media may also be a distributed network, so that the program instructions are stored and executed in a distributed fashion. The non-volatile memory may be a Read Only Memory (ROM), a Programmable Read Only Memory (PROM), an Erasable Programmable Read Only Memory (EPROM), or a flash memory. The volatile memory may be a Random Access Memory (RAM).

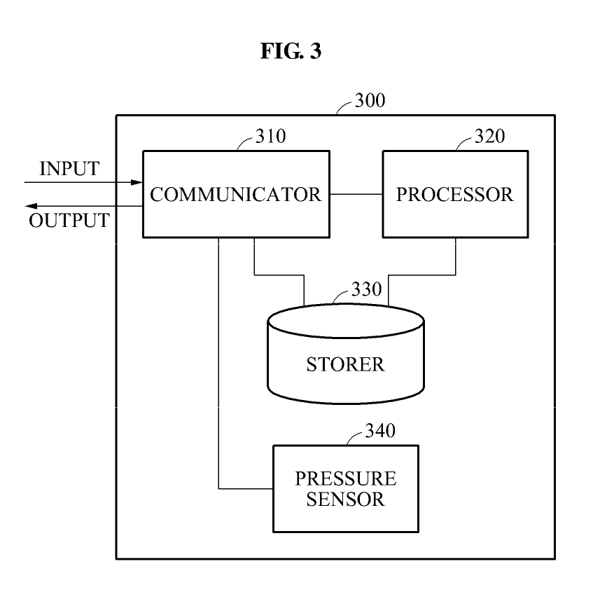

The processor may be, for example, the processor 320, discussed below with reference to FIG. 3. The processor may be implemented by at least one semiconductor chip disposed on a printed circuit board. The processor 320 may be an arithmetic logic unit, a digital signal processor, a microcomputer, a field programmable array, a programmable logic unit, a microprocessor or any other device capable of responding to and executing instructions in a defined manner.

The controller 140 may output different control signals to each of the driving portions 110 associated with a respective one of the legs of the user.

The driving portion 110 may generate a torque based on the control signal output from the controller 140.

The torque may be set by an external device, or may be set by the controller 140.

The walking assistance apparatus 100 may include a right leg driving portion 110 and a left leg driving portion 110.

In an example, the controller 140 may be designed to control one of the driving portions 110. When the controller 140 controls one of the driving portions 110, a plurality of controllers 140 may be provided. In another example, the controller 140 may be designed to control both of the driving portions 110.

The fixing portion 150 may be connected to the driving portion 110 to provide the assistance force to the user based on the torque proved by the driving portion 110. For example, the fixing portion 150 may provide the assistance force to the leg of the user. When the fixing portion 150 is close to the leg of the user, the assistance force may be transferred to the user efficiently. However, when the fixing portion 150 is close to the leg of the user, the user may sense a pressure on the leg or blood circulation may be reduced. In contrast, when the fixing portion 150 is not close to the leg of the user and a gap between the fixing portion 150 and the leg of the user exists, the assistance force may not be properly transferred.

A volume of the body of the user may be changed because muscles are used while the user is walking. Although a clamping force of the fixing portion 150 may be identical while the volume of the body is changed, conventionally, the assistance force may not be effectively transferred to the user.

A method of adjusting a clamping force of a fixing portion will be described in greater detail with reference to FIGS. 3 thorough 13.

<Apparatus for Adjusting Clamping Force>

FIG. 3 is a block diagram illustrating an example of an apparatus for adjusting a clamping force according to at least one example embodiment. Hereinafter, the apparatus for adjusting a clamping force is referred to as a clamping force adjusting apparatus.

Referring to FIG. 3, a clamping force adjusting apparatus 300 may be included in, for example, the walking assistance apparatus 100, however, there is no limitation thereto. For example, the clamping force adjusting apparatus 300 may be included in a general electronic circuit outside of the walking assistance apparatus 100.

The clamping force adjusting apparatus 300 includes a communicator 310, a processor 320, a storer 330, and a pressure sensor 340.

The communicator 310 may exchange data or information with an external apparatus or other apparatuses of the walking assistance apparatus 100. The communicator 310 may be connected with the pressure sensor 340 by a wired communication or a wireless communication.

The communicator 310 may include transmitters and/or receivers. The transmitters may include hardware and any necessary software for transmitting signals including, for example, data signals and/or control signals. The receivers may include hardware and any necessary software for receiving signals including, for example, data signals and/or control signals.

The processor 320 may be a hardware processor. The processor 320 may process data received by the communicator 310 and data stored in the storer 330. For example, the processor 320 may be included in the controller 140. However, example embodiments are not limited thereto.

The processor 320 may be implemented by at least one semiconductor chip disposed on a printed circuit board. The processor 320 may be an arithmetic logic unit, a digital signal processor, a microcomputer, a field programmable array, a programmable logic unit, a microprocessor or any other device capable of responding to and executing instructions in a defined manner.

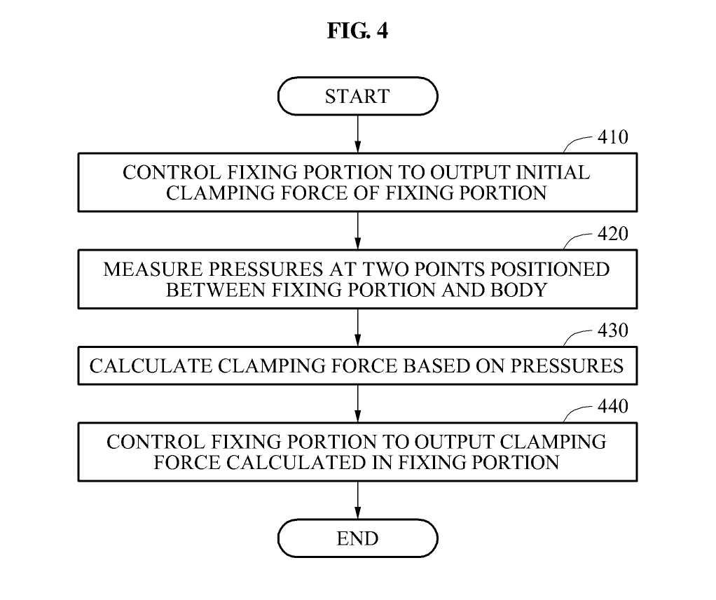

The processor 320 may be programmed with instructions that configure the processor 320 into a special purpose computer to perform the operations illustrated in one or more of FIGS. 4, 7, 8, 12 and 13 such that the processor 320 is configured to calculate a clamping force of the fixing portion 150 based on pressure applied to the legs of the user by the fixing portion 150; and control the fixing portion 150 to output the calculated clamping force to the legs of the user.

Therefore the processor 320 may improve the functioning of the controller 140 and/or the walking assistance device 100 itself by improving transmission efficiency of the claiming force while increasing the wearability of the walking assistance apparatus 100.

The storer 330 may store the data received by the communicator 310 and the data processed by the processor 320.

The storer 330 may be a non-volatile memory, a volatile memory, a hard disk, an optical disk, and a combination of two or more of the above-mentioned devices. The memory may be a non-transitory computer readable medium. The non-transitory computer-readable media may also be a distributed network, so that the program instructions are stored and executed in a distributed fashion. The non-volatile memory may be a Read Only Memory (ROM), a Programmable Read Only Memory (PROM), an Erasable Programmable Read Only Memory (EPROM), or a flash memory. The volatile memory may be a Random Access Memory (RAM).

The pressure sensor 340 may measure a pressure applied to the pressure sensor 340. The pressure sensor 340 may generate a measured pressure value as data. The pressure sensor 340 may transmit the data associated with the generated pressure value to the processor 320 through the communicator 310. Hereinafter, a pressure and a pressure value may be understood having the same meaning and may be used interchangeably.

The communicator 310, the processor 320, the storer 330, and the pressure sensor 340 will be described in greater detail with reference to FIGS. 4 through 13.

FIG. 4 is a flowchart illustrating an example of a method of adjusting a clamping force according to at least one example embodiment.

In FIG. 4, the method is discussed with regards to a first one of the fixing portions 150 is discussed, however, each of the operations discussed herein may also be applied to a second one of the fixing portions 160.

In operation 410, the processor 320 controls the fixing portion 150 to output an initial clamping force of the fixing portion 150. The initial clamping force may be preset. The initial clamping force may be understood as a basic clamping force.

The fixing portion 150 may output the clamping force based on various methods. In an example, the fixing portion 150 may increase the clamping force by decreasing a length of a portion surrounding a body of a user. In another example, the fixing portion may increase the clamping force by increasing a volume of the fixing portion using an air pressure. A method of outputting the clamping force by the fixing portion is not limited thereto, and various methods may be used.

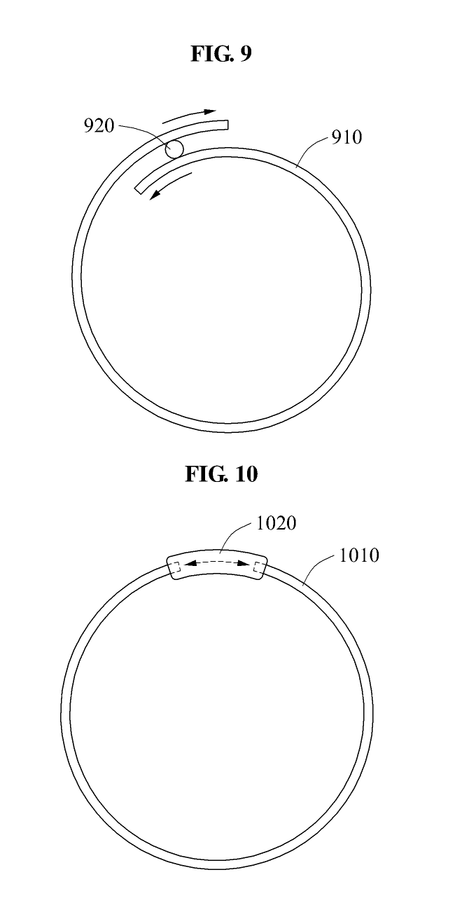

The method of outputting the clamping force by the fixing portion will be described in greater detail with reference to FIGS. 9 through 11.

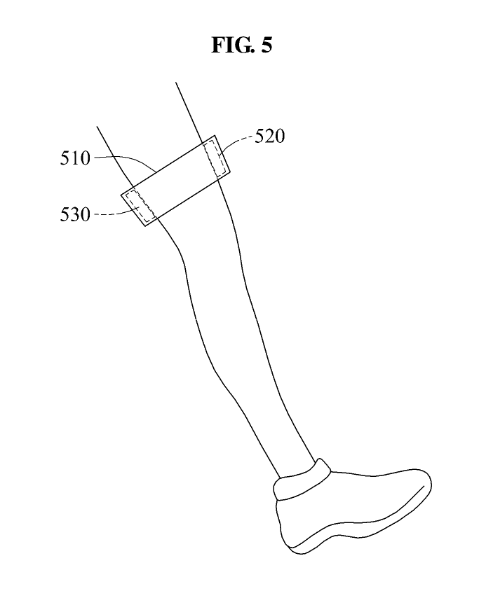

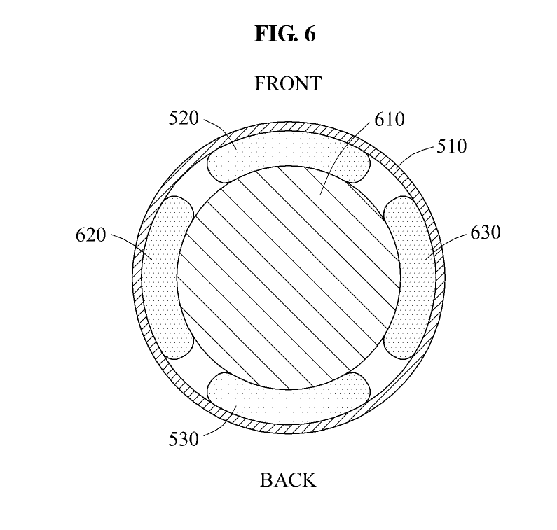

In operation 420, the processor 320 measures pressures at two points positioned between the fixing portion 150 and the body of the user. In an example, the two points may be symmetrical with each other with respect to the body. For example, when the fixing portion is disposed on a femoral portion, the two points may be at a front femoral portion and a back femoral portion of the user, respectively. A disposition of a pressure sensor will be described in greater detail with reference to FIGS. 5 and 6.

In operation 430, the processor 320 calculates the clamping force of the fixing portion based on the measured pressures.

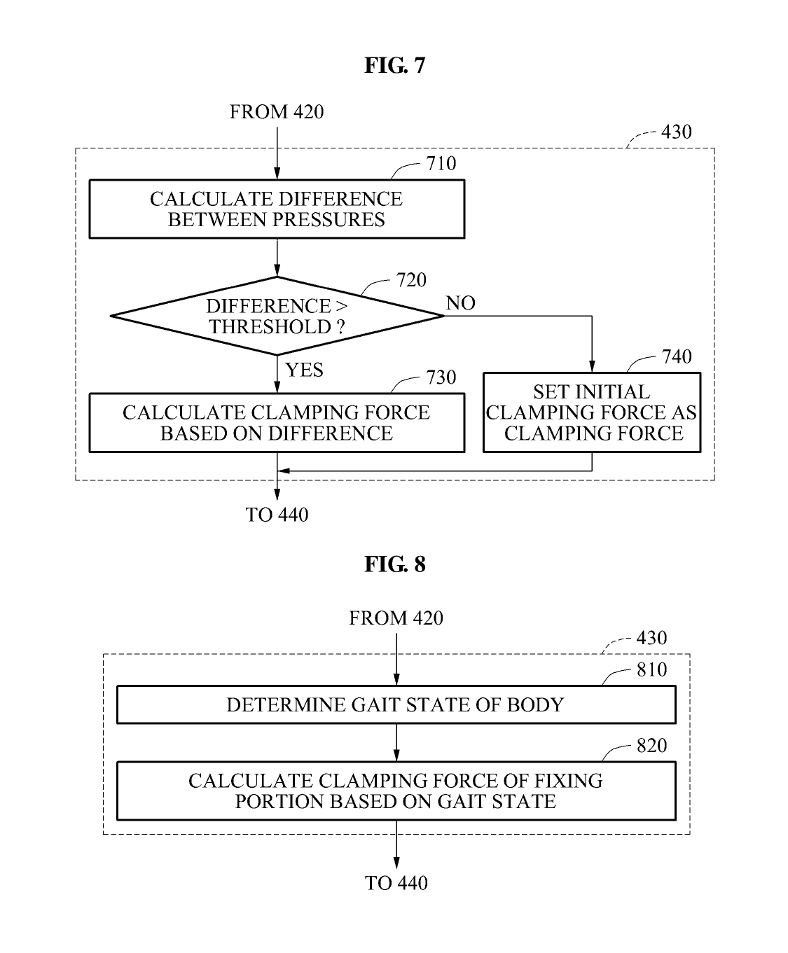

A method of measuring the clamping force will be described in greater detail with reference to FIGS. 7 and 8.

In operation 440, the processor 320 controls the fixing portion 150 to output the calculated clamping force. To control the fixing portion 150, the processor 320 may output a signal or data. The fixing portion 150 may receive a control signal from the processor 320 and output the calculated clamping force based on the received control signal. The method of outputting the clamping force by the fixing portion 150 is not limited thereto.

FIG. 5 illustrates an example of a pressure sensor positioned between a fixing portion and a body according to at least one example embodiment.

Referring to FIGS. 1 and 5, a fixing portion 510 may represent one of the fixing portions 150, 160.

The fixing portion 510 may be disposed on an upper portion of a thigh or a knee of a body of a user. Pressure sensors 520 and 530 may be disposed on between the fixing portion 510 and the body of the user. For example, the pressure sensors 520 and 530 may be symmetrically disposed based on the body of the user. The pressure sensors 520 and 530 may be disposed between the fixing portion 510 and the body and may measure a degree of which the fixing portion 510 pressures the body.

Although the fixing portion 510 is illustrated to be disposed on the upper portion of thigh or knee, the fixing portion 510 may be disposed on a waist, a calf, or an ankle of the user.

FIG. 6 illustrates an example of an arrangement of pressure sensors according to at least one example embodiment.

FIG. 6 is a cross section of a body 610 and the fixing portion 510. In addition to the pressure sensors 520 and 530, additional pressure sensors 620 and 630 may be disposed between the body 610 and the fixing portion 510.

The pressure sensor 520 may be disposed in front of the body 610, and the pressure sensor 530 may be disposed in back of the body 610. The additional pressure sensors 620 and 630 may be disposed at sides of the body.

When the user is ambulatory (or, alternatively, walking), pressures measured by the pressure sensors 520 and 530 may be changed to be larger than pressures measured by the pressure sensors 620 and 630 since the legs of the user are moving back and forth. Since the clamping force is controlled during a gait, the pressure sensors 520 and 530 may provide more reliable pressure data than of the pressure sensors 620 and 630.

In a case in which a side movement of the body requires a measurement during the gait, a pressure sensor, for example, the pressure sensors 620 and 630, disposed at a side of the body may be used.

FIG. 7 is a flowchart illustrating an example of a method of calculating a clamping force according to at least one example embodiment.

Referring to FIGS. 4 and 7, in operation 430, to calculate the clamping force, the processor may perform operations 710 through 740.

In operation 710, the processor 320 may calculate a difference between the measured pressures. The difference may be expressed as shown in Equation 1.

ΔP=|P_{f}−P_{b}| [Equation 1]

P_{f} and P_{b} denote pressures at two measured points, and ΔP denotes a difference between the pressures.

In operation 720, the processor 320 compares the calculated difference to a preset threshold.

When the clamping force is frequently adjusted despite a small difference between the pressures, the user may sense discomfort. To reduce such discomfort, in one or more example embodiments, the processor 320 may utilize a threshold to determine whether to adjust the clamping force. The threshold may prevent the clamping force from being adjusted when the difference between the pressures is not large.

When the processor 320 determines that the calculated difference exceeds the threshold, the processor 320 may perform operation 730. When the processor 320 determines that the calculated difference is less than or equal to the threshold, the processor may perform operation 740.

In operation 730, the processor 320 calculates the clamping force based on the difference between pressures.

In an example, the processor 320 may calculate the clamping force using Equation 2.

F=Fᵢₙᵢ+α*ΔP [Equation 2]

Fᵢₙᵢ denotes an initial clamping force, a denotes a constant, and F denotes the calculated clamping force.

In another example, the processor 320 may calculate the clamping force using Equation 3. The processor 320 may calculate the clamping force based on an assistance force fₐₛₛᵢₛₜ applied to the walking assistance apparatus 100 at a point in time at which the pressures are measured.

$$F = {F}_{ini} + \frac{α * Δ P}{β + {f}_{assist}} \qquad [ Equation 3 ]$$

β denotes a constant, and fₐₛₛᵢₛₜ denotes the assistance force.

In operation 740, the processor 320 sets the initial clamping force as the calculated clamping force when the calculated difference is less than the preset threshold. By setting the calculated clamping force as the initial clamping force, the processor 320 may maintain the clamping force output by the fixing portion without a change.

FIG. 8 is a flowchart illustrating another example of a method of calculating a clamping force according to at least one example embodiment.

Referring to FIGS. 4 and 8, in operation 430, to calculate the clamping force, the processor may perform operations 810 and 820.

In operation 810, the processor 320 determines a gait state of a body attached to a fixing portion 150. For example, when the fixing portion 150 is attached to a left leg, the processor 320 may determine a gait state of the left leg.

In an example, the processor 320 may determine the gait state of the body based on a joint angle of the driver 110 connected to the fixing portion 150. For example, the processor 320 may determine the gait state of the body using a finite state machine.

In another example, the processor 320 may receive information on the gait state of the body from the walking assistance apparatus 100.

For example, the determined gait state may include a stance and a swing.

In operation 820, the processor 320 calculates a clamping force based on the gait state. For example, when the gait state is determined to be a swing, the processor 320 may calculate the clamping force to be greater than of when the gait state is determined to be a stance.

In an example, the processor 320 may calculate the clamping force by additionally considering the gait state based on Equations 2 and 3.

FIGS. 9 and 10 illustrate examples of a fixing portion of which a length is adjusted according to at least one example embodiment.

Referring to FIGS. 9 and 10, in some example embodiments, the fixing portion 150 may include portions 910 and 1010 covering the body of the user and length adjusting apparatuses 920 and 1020 to adjust lengths of the portions 910 and 1010. The length adjusting apparatuses 920 and 1020 may adjust the lengths of the portions 910 and 1010 based on various schemes. However, the length adjusting apparatuses 920 and 1020 are not limited thereto.

The processor 320 may control the fixing portion 150 to output the clamping force calculated in the fixing portion by transmitting a control signal to the fixing portion 150.

When the lengths of the portions 910 and 1010 covering the body decrease, the clamping force may increase. When the lengths of the portions 910 and 1010 covering the body increase, the clamping force may decrease.

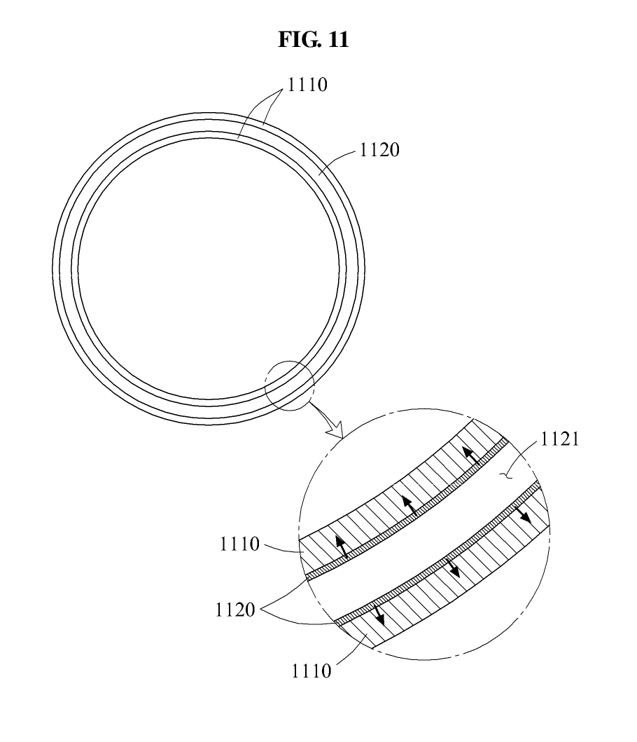

FIG. 11 illustrates an example of an air pressure type fixing portion according to at least one example embodiment.

Referring to FIG. 11, the fixing portion 1110 may include a tube 1120 to adjust a volume of the fixing portion 1110. A material of the tube 1120 may be a material having elasticity. The fixing portion 1110 may inject air to the tube 1120.

A space 1121 in the tube 1120 may be extended due to an injection of air. When the space 1121 is extended, the volume of the fixing portion 1110 may increase. When the volume of the fixing portion 1110 increases, a clamping force may increase.

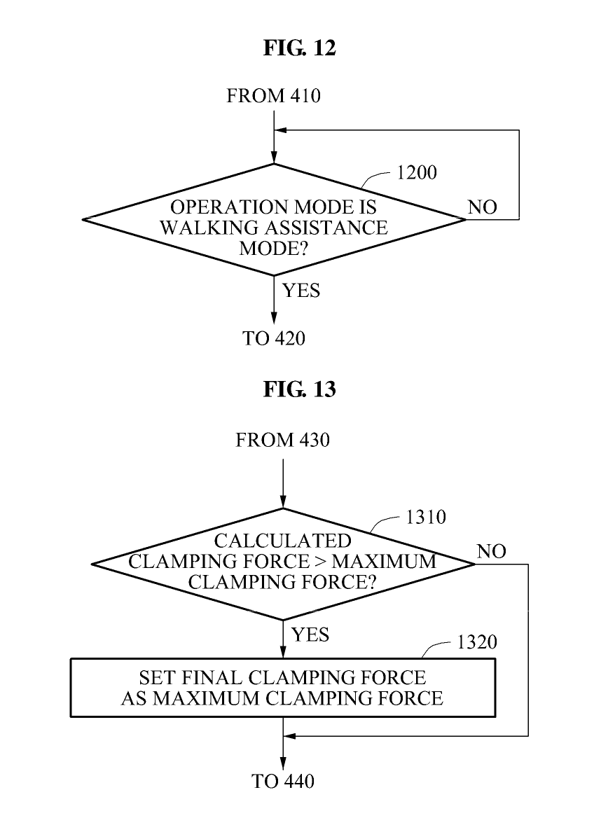

FIG. 12 is a flowchart illustrating an example of a method of determining an operation mode according to at least one example embodiment.

Referring to FIGS. 4 and 12, in some example embodiments, Prior to performing operation 420, the processor 320 may perform operation 1200 such that processor 320 may adjust the clamping force only when a mode of the walking assistance apparatus 100 is a walking assistance mode. For example, when the mode of the walking assistance apparatus 100 is a stop mode, the processor 320 may not adjust the clamping force.

In operation 1200, the processor 320 determines whether an operation mode of the walking assistance apparatus 100 is the walking assistance mode.

The walking assistance mode may be a mode in which the walking assistance apparatus 100 outputs the clamping force to assist a gait of the user.

If the processor 320 determines that the operation mode is not the walking assistance mode, the processor 320 may continue to monitor the operation mode. If the processor 320 determines that the operation mode is the walking assistance mode, the processor 320 may measure the pressor between the fixing portion 150 and the body of the user in operation 420.

FIG. 13 is a flowchart illustrating an example of a method of setting a maximum clamping force according to at least one example embodiment.

Referring to FIGS. 4 and 13, in some example embodiments, the processor 320 may perform operation 1310 m subsequent to calculating the clamping force in operation 430. For example, when the processor 320 determines that a difference between pressures applied to the two points of the body is relatively large, a clamping force to be calculated may be correspondingly large. When the clamping force is relatively large, a user may sense discomfort. To prevent excessive clamping of the fixing portion, a concept of a maximum clamping force may be used.

In operation 1310, the processor 320 compares the calculated clamping force to a maximum clamping force. For example, the maximum clamping force may be preset, and may be differently set according to a user.

In operation 1320, the processor 320 sets a final clamping force as the maximum clamping force when the calculated clamping force exceeds the maximum clamping force.

The units and/or modules described herein may be implemented using hardware components and software components. For example, the hardware components may include microphones, amplifiers, band-pass filters, audio to digital convertors, and processing devices. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is singular; however, one skilled in the art will appreciate that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of adjusting a clamping force applied to a user, the method comprising:
measuring pressures at at least two points between a fixing portion of a walking assistance apparatus and a body of the user;
calculating an adjusted clamping force of the fixing portion based on the pressures; and
controlling the fixing portion to apply the adjusted clamping force to the user.

2. The method of claim 1, further comprising:
controlling the fixing portion to apply an initial clamping force to the user.

3. The method of claim 1, further comprising:
determining if an operation mode of the walking assistance apparatus is a walking assistance mode; and
wherein the measuring measures the pressures when the determining determines that the operation mode is the walking assistance mode.

4. The method of claim 1, wherein the calculating of the adjusted clamping force comprises:
calculating a difference between the pressures; and
calculating the adjusted clamping force based on the difference.

5. The method of claim 4, wherein the calculating of the adjusted clamping force based on the difference comprises:
maintaining an initial clamping force when the difference is less than a threshold.

6. The method of claim 4, wherein the calculating of the adjusted clamping force based on the difference comprises:
calculating the adjusted clamping force based on the difference and an assistance force applied to the walking assistance apparatus when the measuring the pressures measures the pressures at the at least two points.

7. The method of claim 1, further comprising:
comparing the adjusted clamping force to a maximum clamping force; and
setting the adjusted clamping force as a maximum clamping force when the adjusted clamping force exceeds the maximum clamping force.

8. The method of claim 1, wherein the calculating of the adjusted clamping force comprises:
determining a gait state of the body; and
calculating the adjusted clamping force based on the gait state.

9. An apparatus configured to adjust a clamping force applied to a user, the apparatus comprising:
a pressure sensor configured to measure pressures at at least two points between a fixing portion of a walking assistance apparatus and a body of the user; and
a processor configured to,
calculate an adjusted clamping force of the fixing portion based on the pressures, and
control the fixing portion to apply the adjusted clamping force to the user.

10. The apparatus of claim 9, wherein the two points are symmetrical with each other with respect to the body.

11. The apparatus of claim 9, wherein the processor is configured to control the fixing portion to apply the adjusted clamping force by adjusting an amount of air in the fixing portion.

12. The apparatus of claim 9, wherein the processor is configured to control the fixing portion to apply the adjusted clamping force by adjusting a length of the fixing portion.

13. The apparatus of claim 9, wherein the processor is configured to control the fixing portion to apply an initial clamping force to the user.

14. The apparatus of claim 9, wherein
the processor is configured to,
determine if an operation mode of the walking assistance apparatus is a walking assistance mode, and
instruct the pressure sensor to measure the pressures when the operation mode is the walking assistance mode.

15. The apparatus of claim 9, wherein the processor is configured to,
calculate a difference between the pressures, and
calculate the adjusted clamping force based on the difference.

16. The apparatus of claim 9, wherein the processor is configured to, compare the adjusted clamping force to a preset maximum clamping force, and
set the adjusted clamping force as a maximum clamping force when the adjusted clamping force exceeds the maximum clamping force.

17. The apparatus of claim 9, wherein the processor is configured to determine a gait state of the body and calculate the adjusted clamping force based on the gait state.
